(19) United States
(12) Patent Application Publication
(10) Pub. No.: US 2015/0302235 A1
(43) Pub. Date: Oct. 22, 2015

(54) RACE TIMING SYSTEM

(71) Applicants: Griffin E. Kelly, Chicago, IL (US); Elliot J. Hevel, Orland Park, IL (US)

(72) Inventors: Griffin E. Kelly, Chicago, IL (US); Elliot J. Hevel, Orland Park, IL (US)

(73) Assignee: TIMING AND RACING AROUND THE CLOCK LLC, Chicago, IL (US)

(21) Appl. No.: 14/688,325

(22) Filed: Apr. 16, 2015

Related U.S. Application Data
(60) Provisional application No. 61/980,251, filed on Apr. 16, 2014.

(51) Int. Cl. G06K 7/10; A63B 24/00

(52) U.S. Cl. CPC G06K 7/10425; A63B 24/0021

(57) ABSTRACT

A race timing system 10 includes a remote system server 30 and one or more detector units 20 in operative communication therewith. The detector units 20 detect the presence of race participants 14 at selected locations along an established racecourse, via RFID tags 12 carried by the participants 14. The time that participants 14 are detected at given locations is also noted. The relevant data is forwarded to the server 30, which based thereon, determines race results and/or timing data, e.g., such a participant's pace, split times, net race completion time, etc.

### BACKGROUND

The subject matter of the present specification relates to the art of race timing systems. Exemplary embodiments disclosed herein find particular application in conjunction with footraces, and they will be described herein with particular reference thereto. However, it is to be appreciated that various exemplary embodiments such as those disclosed herein are also amenable to other like applications and/or other types of races, e.g., such as bicycle races, wheelchair races, horse races, etc.

Systems have been developed which use Radio Frequency IDentification (RFID) technology, including RFID readers and RFID tags, to track objects. RFID technology has also been used in one way or another in connection with some race timing systems. See the following, for example, all of which are incorporated herein by reference in their entirety:
International Applications published under the Patent Cooperation Treaty (PCT), Publication Nos.: WO 2013/063432; WO 2010/138882; and WO 2010/138890; and,
U.S. Patent Application Publications, Publication Nos.: US 2010/0302910; US 2011/0233281; US 2011/0233282; and US 2012/0072172.

However, many prior art race time systems have exhibited some form of flaw, drawback, limitation and/or other undesirable characteristic.

Accordingly, a new and/or improved race timing method, system and/or apparatus is disclosed herein.

### BRIEF DESCRIPTION

This Brief Description is provided to introduce concepts related to the present inventive subject matter. It is not intended to identify essential features of the claimed subject matter nor is it intended for use in determining or limiting the scope of the claimed subject matter. The exemplary embodiments described below are not intended to be exhaustive or to limit the invention to the precise forms disclosed in the following Detailed Description. Rather, the embodiments are chosen and described so that others skilled in the art may appreciate and understand the principles and practices of the present inventive subject matter.

In accordance with one aspect of the present inventive subject matter, a race timing system is provided that collects and processes race data for one or more racers progressing along a racecourse. The race timing system includes: a plurality of Radio Frequency IDentification (RFID) tags, each RFID tag being provisioned with an identifier which is distinguishable from the identifiers of the other RFID tags and each RFID tag being borne by a corresponding racer to thereby identify said corresponding racer with the identifier that the RFID tag is provisioned with; and a plurality of detector units, each detector unit being located at a point along the racecourse. Each detector unit includes: an RFID reader that wirelessly obtains the identifiers from the RFID tags as they pass by the detector unit; and a wireless transmitter that obtains the identifiers from the RFID reader and wirelessly transmits the obtained identifiers over a wireless telecommunications network. The system further includes a computer configured to operate as a server operatively connected to the wireless telecommunications network so as to receive the identifiers sent from the detector units, the computer being remotely located from the detector units.

In accordance with another aspect of the present inventive subject matter, a method is provided for establishing a racecourse and collecting and processing race data for one or more racers progressing along said racecourse. The method includes: providing a plurality of Radio Frequency IDentification (RFID) tags to a plurality of racers, each RFID tag being provisioned with an identifier which is distinguishable from the identifiers of the other RFID tags and each RFID tag being borne by a corresponding racer to thereby identify the corresponding racer with the identifier that the RFID tag is provisioned with; positioning a plurality of detector units in an area where the racecourse is to be located; selecting a first subset of the plurality of detector units, the selected subset of detector units defining a path which the racecourse follows; wirelessly obtaining the identifiers from the RFID tags with the selected detector units as the RFID tags pass by the selected detector units; wirelessly transmitting the obtained identifiers from the selected detector units over a wireless telecommunications network; and receiving the transmitted identifiers at a server remotely located from the plurality of detector units.

Numerous advantages and benefits of the inventive subject matter disclosed herein will become apparent to those of ordinary skill in the art upon reading and understanding the present specification. It is to be understood, however, that the detailed description of the various embodiments and specific examples, while indicating preferred and/or other embodiments, are given by way of illustration and not limitation. Many changes and modifications within the scope of the present invention may be made without departing from the spirit thereof, and the invention includes all such modifications.

### BRIEF DESCRIPTION OF THE DRAWINGS

The following Detailed Description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a diagrammatic illustration showing an exemplary race timing system in accordance with aspects of the present inventive subject matter.

FIG. 2 is a diagrammatic illustration showing an exemplary interface for establishing a racecourse by selecting a collection of detector units defining said racecourse in accordance with aspects of the present inventive subject matter.

### DETAILED DESCRIPTION

For clarity and simplicity, the present specification shall refer to structural and/or functional elements, relevant standards, algorithms and/or protocols, and other components, methods and/or processes that are commonly known in the art without further detailed explanation as to their configuration or operation except to the extent they have been modified or altered in accordance with and/or to accommodate the preferred and/or other embodiment(s) presented herein. Moreover, the apparatuses and methods disclosed in the present specification are described in detail by way of examples and with reference to the figures. Unless otherwise specified, like numbers in the figures indicate references to the same, similar or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific materials, techniques, arrangements, etc. are either related to a specific example presented or are merely a general description of such a material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to the figures.

In general, there is disclosed herein a race timing system that is used to track, monitor, collect, record, collate, compare, organize, share and/or output race timing results and/or other data for one or more race participants. For example, these results and/or data may include the pace of participants, one or more split times of participants, the net time it takes participants to complete a race, etc. Suitably, in practice, each race participant is equipped with an RFID tag, e.g., a passive Ultra-High Frequency (UHF) RFID tag, which is worn by, held and/or otherwise attached to the participant. Alternatively, semi-passive or active RFID tags may be employed. Suitably, each RFID tag is programmed or otherwise provisioned with a separate distinguishing identifier (e.g., an alphanumeric string or code) which is ultimately associated in the system with the participant that has been equipped with that RFID tag. As each participant (along with their RFID tag) passes by an RFID reader at one or more selected locations along the course or path of the race, the RFID reader reads the participant's RFID tag, e.g., the RFID reader wirelessly obtains the identifier from the RFID tag when the tag comes within sufficient proximity to the reader. For example, RFID readers may be located at the starting line of the racecourse, intermittently at various locations along the racecourse, and at the finish line of the racecourse. In this way, race participants are detected at the given locations of the RFID readers along the racecourse, e.g., via the associated identifiers readout and/or otherwise obtained from the participants' RFID tags by the RFID readers at those given locations. In one exemplary embodiment, the time at which each participant is detected at a given location is noted by the system, e.g., using a master clock or otherwise. For example, a readout identifier is suitably associated with a timestamp (e.g., supplied by and/or obtained from a suitable clock) which indicates the time that the identifier was readout from the RFID tag and/or obtained by the RFID reader. Based on the timestamps and/or noted times a given participant is detected at given locations, the system computes and/or otherwise determines one or more of the participant's pace, split times and/or net time taken to complete the race.

In one suitable embodiment, identifiers readout from RFID tags by the RFID readers, along with their associated timestamps and/or the noted times that the identifiers are obtained by the RFID readers, are uploaded in real-time or nearly real-time to a remote server, e.g., via a wireless telecommunication network and/or data network. In practice, the wireless telecommunication network may by a cellular or mobile or other like network, e.g., such as a GSM (Global System for Mobile Communications) network, a UTMS (Universal Mobile Telecommunications System) network, an LTE (Long-Term Evolution) network, etc. Suitably, the data network may be the Internet, for example. The server uses the received identifiers and timestamps to compute and/or otherwise determine the race timing results and/or data (e.g., pace, split times, net race completion time, etc.) for the respective participants associated with the identifiers. In practice, these results are updated in real-time or near real-time as data is uploaded to the server. Suitably, updated race results and/or data are posted in real-time or near real-time and can be accessed by participants (and/or optionally others), e.g., via a suitable program and/or application running on a participant's smartphone, tablet or other wireless, mobile and/or Internet connected device. Optionally, the same program or application can be used by participants to register for a given race, e.g., which may be set-up, programmed, provisioned, organized and/or coordinated on the server via another suitable interface. In one optional embodiment, the server can automatically send relevant race results and/or data to the participants and/or the participants' devices, e.g., in real-time or near real-time as the results and/or data are updated. The race results available from and/or sent by the server may optionally include individual results for a given participant as well as a participant's results relative to other participants (e.g., a participant's rank or placement relative to other participants).

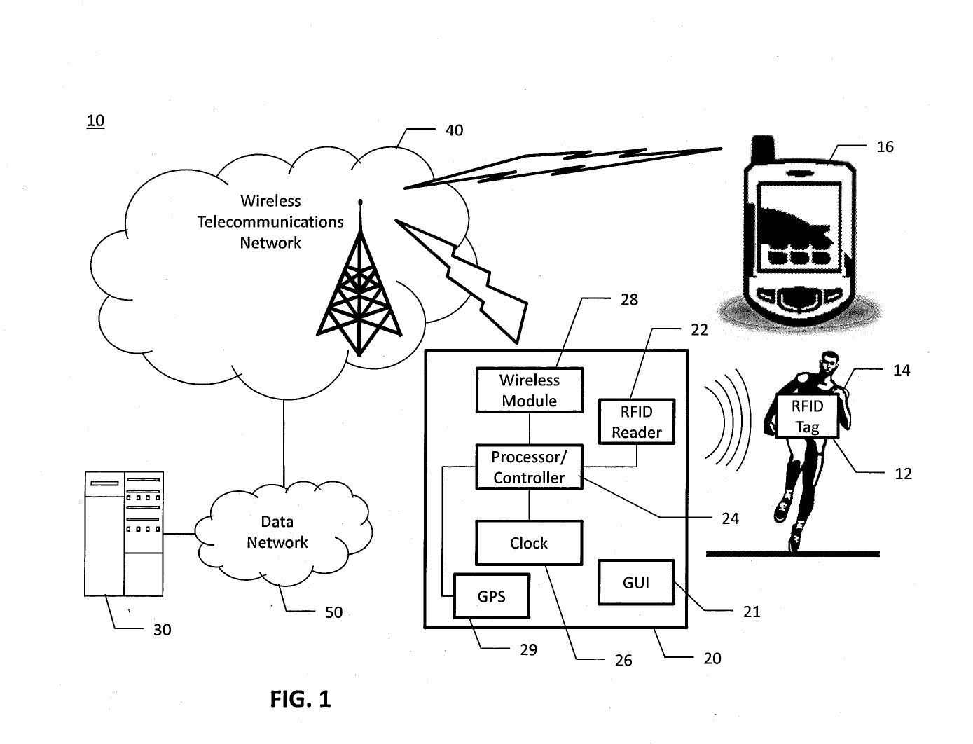

With reference now to FIG. 1, there is shown an exemplary race timing system 10. The system 10 includes one or more RFID tags 12 which are borne by respective racers or race participants 14. FIG. 1 illustrates only a single racer or participant 14 equipped and/or provisioned with a single RFID tag 12, however in practice, there may be a plurality of racers or participants 14 similarly bearing respective RFID tags 12. Optionally, to ensure a racers tag is read at the appropriate time and/or location, a racer or participant 14 may carry multiple similarly provisioned tags 12 (i.e., with the same identifier or ID, etc.). Suitably, the RFID tags 12 are passive UHF RFID tags, e.g., which may be carried by the participants 14. Optionally, the tags 12 are integrated in and/or attached to the clothing and/or gear worn and/or otherwise borne by the participants, e.g., such as in or on a race bib, a shoe, an armband, a watch, etc. In one suitable embodiment, the RFID tags 12 may be disposable (i.e., usable for a single race or a relatively limited or small number of races), and in another suitable embodiment, the RFID tags 12 may be sufficiently more durable and/or permanent (i.e., usable for many or an otherwise relatively larger number of races). In practice, each RFID tag 12 is programmed with and/or provisioned to store (e.g., in an electronic memory or elsewhere) a suitably distinguishable identifier. For example, the identifier of each RFID tag 12 may be an alphanumeric string or other suitable code or the like. For a given race, suitably, each identifier is different from the other identifiers such that each participant 14 in the race is equipped with an RFID tag 12 having a different identifier.

At various points along a path of a racecourse, there are located detector units 20. FIG. 1 depicts only a single unit 20. However, in practice, there may be a plurality of such units 20 within the system 10 positioned at strategic and/or otherwise desired locations along the path of a racecourse. In theory, the number of units 20 may be essentially unlimited. For example, one unit 20 may be located at a racecourse starting line, other units 20 can be periodically and/or intermittently located along a path of the racecourse, and yet another unit 20 may be located at a finish line of the racecourse. Suitably, the units 20 are relatively stationary and/or permanently secured and/or installed at their locations (i.e., affixed to their given position). In one exemplary embodiment, multiple units 20 are located in and/or around a desired region or area where races are to be conducted, e.g., throughout a park, a track facility or stadium, a metropolitan area or other geographic region. A racecourse is then plotted or selected by choosing a number of the units 20 (e.g., in a designated order and/or sequence) which in turn defines the starting line, path and finish line of the racecourse. Optionally, for any given race, the racecourse may be defined using all the installed units 20 or some subset of the units 20, e.g., which incorporates less than all the units 20. Accordingly, altering the path of a racecourse or defining a new racecourse, merely involves the selection of a new and/or different subset of the units 20. In this way, the path of the racecourse is altered or a new course is defined without having to move or change the positions of the units 20. Moreover, it is to be appreciated that multiple different racecourses can simultaneously be defined and/or run by selecting a plurality of different subsets of the units 20, where each subset corresponds to and/or defines the path of a different racecourse.

In one exemplary embodiment, one or more of the units 20 are installed above ground over potential racecourses out of the way and/or physical reach of participants 14 and/or other passers-by, e.g., so as to not be readily subject to vandalism and/or other unauthorized access. For example, the units 20 may be installed on and/or attached to light, utility, sign, street and/or other like posts. Although, in another suitable embodiment, one or more of the units 20 may be installed at or below ground level, e.g., in or on a sidewalk or roadway. In accordance with at least one exemplary embodiment, the units 20 are generally intended to be permanent or at least semi-permanent outdoor fixtures and they are therefore suitably encapsulated in weather proof or weather resistant housings. In another exemplary embodiment, the units 20 may be portable and/or self-contained, e.g., so that they can be moved to and from and/or otherwise arranged in various venues, tracks and/or regions. Optionally, the units 20 may be battery powered, powered via a solar panel or the like or powered via a connection to an electrical power grid.

As shown in the illustrated embodiment, each detector unit 20 suitably includes an RFID reader 22, a controller 24 (e.g., implemented via a microprocessor, microcontroller or the like), a clock 26 and a wireless telecommunication module 28. In one advantageous embodiment, the controller 24 takes the form of a somewhat rudimentary microprocessor or microcontroller or the like, relieving the unit 20 of the burden and/or expense of having to carry and/or support a more complex and/or sophisticated computer. In practice, the controller 24 optionally controls and/or regulates the operation of one or more of the other components and/or elements of the unit 20. As shown, the unit 20 optionally includes a graphical user interface (GUI) or the like which may selectively be employed to easily set-up, provision, program or otherwise input operational parameters or the like for the unit 20. In operation during a race, as each racer or participant 14 (along with their RFID tag 12) passes by an RFID reader 22 at one or more selected locations along the course or path of the race, the RFID reader 22 reads the participant's RFID tag 12, i.e., the RFID reader 22 wirelessly obtains the identifier from the RFID tag 12 when the tag 12 comes within sufficient proximity to the reader 22. In this way, a given detector unit 20 detects the presence of the RFID tag 12 (and consequently the presence of the racer or participant 14 bearing the tag 12) at the location of the given unit 20.

Suitably, the identifier obtained from the RFID tag 12 by the RFID reader 22 is passed to and/or otherwise obtained by the controller 24 from the reader 22. In one suitable embodiment, the controller 24 is a separate controller distinct from an internal controller of the RFID reader 22. Suitably, the time at which each identifier is obtained by the RFID reader 22 is noted and the noted time is associated with the identifier that the time was noted for. For example, having obtained an identifier from the RFID reader 22, the controller 24 in turn queries and/or accesses the clock 26 to obtain therefrom a timestamp or the like which indicates the time that the detector unit 20 detected the presence of the tag 12 and/or participant 14 at the location of the unit 20 (e.g., the time at which the reader 22 obtained the identifier from the tag 12). Suitably, the clock 26 in each unit 20 is a radio or radio-controlled clock, e.g., synchronized to and/or with a master clock, such as a national atomic clock. In this way, the clocks 26 in all the units 20 are similarly synchronized with one another. In other embodiments, the units 20 can synchronize to a common time or temporal reference point via other suitable methods, e.g., by synchronizing to a national atomic clock server over a general telecommunications network or other one or more of the networks 40 and/or 50, optionally using the module 28, or by using an internal clock included with the RFID reader 22. Optionally, the clock 26 can be synched via a Global Positioning System (GPS) receiver 29, using GPS synchronization.

Having obtained an identifier and corresponding timestamp, the controller 24 pairs, couples and/or otherwise associates the obtained timestamp or other like time indicator with the corresponding obtained identifier and forwards the same (i.e., the paired data) to the wireless telecommunications module 28. Suitably, the telecommunications module 28 is in operative communication with a remote system server 30, e.g., via a wireless telecommunications network 40 providing wireless telecommunication service to the module 28 and/or a data network 50. In practice, the wireless telecommunication network 50 may be a cellular or mobile or other like network, e.g., such as a GSM (Global System for Mobile Communications) network, a UTMS (Universal Mobile Telecommunications System) network, an LTE (Long-Term Evolution) network, etc.; and the telecommunications module 28 comprises a mobile cellular radio transmitter. Suitably, the data network 50 may be the Internet, for example. In practice, a computer or other like data processing device is configured to operate as the server 30, which computer or the like is operatively connected to the wireless telecommunications network 40, e.g., via the data network 50.

Having received the paired data (i.e., the RFID tag identifier and timestamp) from the controller 24, the telecommunication module 28 in turn forwards, sends and/or otherwise transmits the paired data to the remote system server 30 (e.g., via the wireless telecommunication network 40 and/or the data network 50). Suitably, the detector units 20 send data (e.g., the obtained identifiers and/or adjunct data) to the server in real or near-real time as it is obtained and/or otherwise generated. For example, the transmission module 28 transmits the paired identifiers and timestamp information in real or near-real time as the identifiers are obtained by the RFID reader 22. In turn, the server 30 receives the paired date in real-time or near real-time as it is collected by the detector units 20 and correspondingly updates race data in real or near-real time.

It is to be appreciated that during the course of a race, the server 30 is receiving paired data for various different participants from various different detector units 20 at different locations along the racecourse. Suitably, along with the paired data sent to server 30, each detector unit 20 may also send a suitably distinguishable unit indicator or other suitable signal that the server 30 can use to resolve and/or otherwise determine the source of the accompanying and/or otherwise associated paired data. In one suitable embodiment, for example, the telecommunications module 28 is equipped with a GPS receiver 29 or the like, and upon forwarding, sending or otherwise transmitting the paired data to the remote system server 30, the module 26 may also forward, send or otherwise transmit its GPS coordinates, location data or the like to the remote system server 30. Optionally, the server 30 is programmed or otherwise provisioned with information or data that correlates a detector unit's location with a unit indicator or signal, e.g., that is forwarded along with the paired data.

Accordingly, the server 30 uses the received GPS coordinates or other unit indicator or signal (received and/or associated with the paired data) to resolve and/or otherwise determine which unit 20 the pair data is coming from, and consequently the corresponding location to which the paired data belongs. In this way, the server 30 knows or is able to determine which participant data corresponds to (e.g., from the RFID tag identifier contained in the paired data), the location at which that participant is detected (e.g., from the received GPS coordinates and/or the indication of the unit 20 from which the paired data was received), and the time at which that participant was detected at that location (e.g., from the timestamp or other time indicator contained in the paired data).

Having received the aforementioned data from various detector units 20 and made the aforementioned determinations, the server 30 uses the same to compute and/or otherwise determine the race timing results and/or data (e.g., pace, split times, net race completion time, etc.) for the respective racers or participants 14. In practice, these results are updated in real-time or near real-time as data is uploaded to the server 30. Suitably, updated race results and/or data are posted in real-time or near real-time and can be accessed from the server 30 by participants 14 (and/or optionally others), e.g., via a suitable program and/or application running on a participant's smartphone 16 or other wireless, mobile and/or Internet connected device. Optionally, the same program or application can be used by participants 14 to register for a given race, e.g., which may be set-up, programmed, provisioned, organized and/or coordinated on the server 30 via another suitable interface. In one optional embodiment, the server 30 can automatically send relevant race results and/or data to the participants 14 and/or the participants' devices 16, e.g., in real-time or near real-time as the results and/or data are updated. The race results available from and/or sent by the server 30 may optionally include individual results for a given participant 14 as well as a participant's results relative to other participants 14 (e.g., a participant's rank or placement relative to other participants 14). In one suitable embodiment, users and/or participants 14 are able to interact with each other via the server 30 and/or the system 10 (e.g., using the application or program running on their device 16), to challenge each other and/or invite one another to run a race or particular course, to share their results and/or view others' results, etc.

Having described various embodiments above, examples will now be provided to illustrate how the system 10 may be used and/or how it operates.

Suitably, the server 30 in one mode operates to permit a race coordinator to establish a race event. In this mode, the server 30 is accessed by the race coordinator, suitably, using a client computer or other like device to access the server 30, e.g., via the network 50 and/or wireless network 40. Optionally, the same application running on device 16 (which is used to receive race results) may be used to establish a race event. Optionally, a participant 14 may define his own course and/or race event.

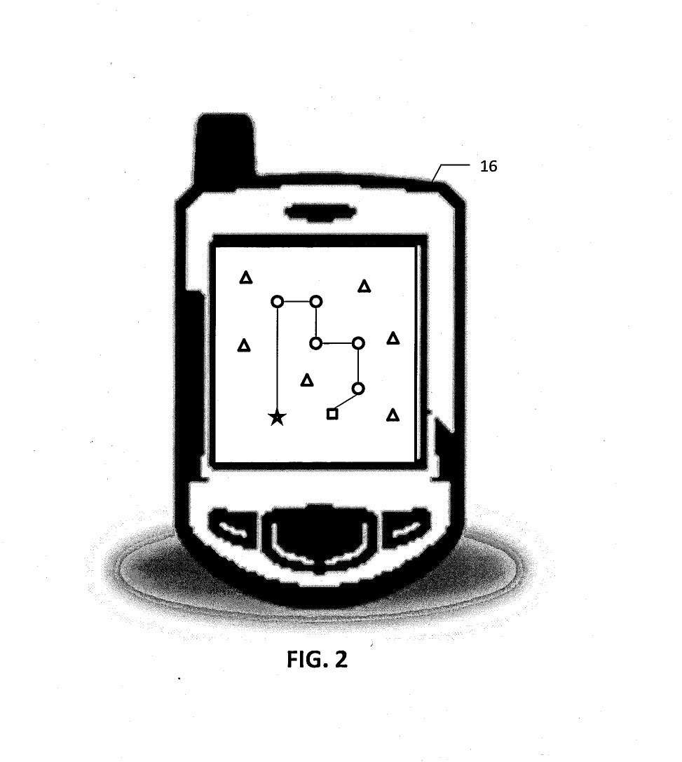

In this mode, the server 30 suitably provides the coordinator with an interface that can be used to select the race parameters which will define the race event. Suitably, the server 30 saves (e.g., in a memory, database (DB) or otherwise) the race parameters for each race event so established. For example, the coordinator may select which detector unit 20 will be assigned as the starting point of the racecourse, which detector unit 20 will be assigned as the finish point of the racecourse and which detector units 20 (along with a sequence or order) will be used to define the path of the racecourse. For example, FIG. 2 illustrates an example graphical user interface (GUI) on a device 16 in which the coordinator has selected a subset of the detector units 20 in the system 10 to define a racecourse for a given race event. In the illustrated example, the square icon represents the selected starting point (corresponding to the location of one of the detector units 20), the circle icons represent selected detector units 20 defining the path of the racecourse, and the star icon represents the selected finish point (corresponding to the location of one of the detector units 20). Suitably, as shown, a line or line segments connecting the forgoing points depict the defined racecourse. In this example, the triangle icons represent other detector units 20 that were not selected for this particular race event. Suitably, while not shown here for the sake of clarity, the graphic may be overlaid on a topographic, satellite, road or other map showing the geographic region in which the detector units 20 are located. It is to be appreciated, that for different race events, different racecourses may be defined depending on the selection of different detector units 20 as being assigned to different points along the racecourse.

In addition to defining the layout of the racecourse, the server 30 may also permit and/or request that the coordinator enter relevant time and/or date information for when the race event being established is to be run. In one suitable embodiment, the race event may have a designated start time and/or date, in which case the coordinator simply enters the desired start time and/or date. In another suitable embodiment, a race event may have a window of opportunity (be it hours longs, days long, weeks long, etc.) in which participants 14 may selectively choose when they wish to run the race. In this manner, race participants 14 (while ostensibly still competing against one another) do not all have to run the race concurrently. Suitably, for such race events, the opening time/date of the window and closing time/date of the window are entered by the coordinator. The server 30 is in this way instructed to continue obtaining and/or updating race results for this race event during the period of the defined window. Of course, it is to be appreciated that at any given point in time, one or more race events may be established with the server 30 and/or at any given point in time one or more race events may be ongoing and/or administered by the server 30. Accordingly, for each race event, a suitably distinguishable race identifier is generated (e.g., by the server 30) and associated with the race event so that the server 30 can resolve and/or otherwise determine which incoming and/or outgoing data belongs to which race event.

In a second mode, the server 30 operates to register participants 14 to compete in selected race events established with and/or saved on the server 30. Again, a participant may use the aforementioned program or application running on their device 16 to access the server 30 and/or register for one or more particular race events. In one suitable embodiment, the server 30 supplies an interface (e.g., in the form of webpage or the like) in which the participant can enter their personal information, e.g., such as their name, telephone number and/or e-mail address where the participant would like race results sent, any payment information if there is a fee for participating in the event they are registering for, etc. Suitably, the server 30 stores and correlates the input personal information with the identifier stored on the RFID tag 12 with which the participant is equipped. Optionally, the RFID tag identifier may be input by the participant along with their other personal information, e.g., using a suitable RFID reader or otherwise. It is to be appreciated that suitably a race participant can register for a race event any time before the event begins, and the registration will be saved by the server 30. In one suitable embodiment, the server 30 provides the participant a list of the established race events from which the participant may select one or more events for which they wish to register. In this way, the server 30 is made aware of which RFID tag identifiers are registered to compete in which race events and the server 30 can therefore process received signals and/or data from the detector units 20 accordingly.

While the description herein refers specifically to races and/or race events, it is to be appreciated that the system is equally applicable and may optionally be used for training, personal fitness and/or other recreational purposes. Individual participants 14 may optionally select and/or define a desired course and simply run it themselves as a training exercise or merely for enjoyment. The system 10 (e.g., via the server 30, the participants device 16 and/or otherwise) may record and/or maintain various results (paces, split times, net completion times, etc.) for various participants 14 and/or for various courses. A participant's results can then be accessed and/or compared to monitor their progress and/or improvement (or lack thereof) over time, e.g., with respect to a particular course run on multiple occasions or otherwise. Multiple participants 14 may also optionally compare their results to one another.

Various aspects of inventive subject matter have been described herein with reference to exemplary and/or preferred embodiments. Obviously, modifications and alterations will occur to others upon reading and understanding the preceding detailed description. It is intended that the inventive subject matter be construed as including all such modifications and alterations insofar as they come within the scope of the appended claims or the equivalents thereof.

The above methods, system, platforms, modules, processes, algorithms and/or apparatus have been described with respect to particular embodiments. It is to be appreciated, however, that certain modifications and/or alteration are also contemplated.

It is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, methods, functions, elements and/or components described herein may suitably be implemented via hardware, software, firmware or a combination thereof. In particular, the RFID tags 12, detector units 20, RFID readers 22, controllers 24, clocks 26, modules 28, server 30 and/or user devices 16 may be embodied by processors, electrical circuits, computers and/or other electronic data processing devices that are configured and/or otherwise provisioned to perform one or more of the tasks, steps, processes, methods and/or functions described herein. For example, a processor, computer or other electronic data processing device embodying a particular element may be provided, supplied and/or programmed with a suitable listing of code (e.g., such as source code, interpretive code, object code, directly executable code, and so forth) or other like instructions or software or firmware, such that when run and/or executed by the computer or other electronic data processing device one or more of the tasks, steps, processes, methods and/or functions described herein are completed or otherwise performed. Suitably, the listing of code or other like instructions or software or firmware is implemented as and/or recorded, stored, contained or included in and/or on a non-transitory computer and/or machine readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, methods, functions, elements and/or components described herein may be implemented on and/or embodiment in one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, methods and/or functions described herein can be used.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A race timing system that collects and processes race data for one or more racers progressing along a racecourse, said race timing system comprising:
a plurality of Radio Frequency IDentification (RFID) tags, each RFID tag being provisioned with an identifier which is distinguishable from the identifiers of the other RFID tags and each RFID tag being borne by a corresponding racer to thereby identify said corresponding racer with the identifier that the RFID tag is provisioned with;
a plurality of detector units, each detector unit being located at a point along said racecourse and comprising:
an RFID reader that wirelessly obtains the identifiers from the RFID tags as they pass by the detector unit; and
a wireless transmitter that obtains the identifiers from the RFID reader and wirelessly transmits the obtained identifiers over a wireless telecommunications network; and
a computer configured to operate as a server operatively connected to the wireless telecommunications network so as to receive the identifiers sent from the detector units, said computer being remotely located from the detector units.

2. The race timing system of claim 1, wherein the wireless transmitter is a mobile cellular radio transmitter and the wireless telecommunications network is a cellular telecommunications network serving the mobile cellular radio transmitter.

3. The race timing system of claim 2, wherein the cellular telecommunications network is one of a Global System for Mobile Communications (GSM) network, a Universal Mobile Telecommunications System (UTMS) network or a Long-Term Evolution (LTE) network.

4. The race timing system of claim 1, wherein each detector unit further comprises:
a clock, said detector unit being operative to (i) note a time provided by said clock for each particular identifier obtained by the RFID reader, and (ii) associate the noted time with the identifier for which the time was noted, said wireless transmitter wirelessly transmitting the associated identifier and time pairs to the server over the wireless telecommunications network.

5. The race timing system of claim 1, wherein each detector unit is provisioned with a unit indicator which is distinguishable from the unit indicators of the other detector units, said wireless transmitter of each detector unit being operative to wirelessly transmit the detector unit's unit indicator along with the RFID tag identifiers sent to the server over the wireless telecommunications network.

6. The race timing system of claim 5, wherein the server employs received unit indictors to determine which detector unit received identifiers are coming from.

7. The race timing system of claim 1, wherein each detector unit further comprises:
a Global Positioning System (GPS) receiver that provides location data indicative of a location of the detector unit, said wireless transmitter of each detector unit being operative to wirelessly transmit the location data obtained from the GPS receiver along with the RFID tag identifiers sent to the server over the wireless telecommunications network.

8. The race timing system of claim 1, wherein the wireless transmitter of each detector unit wirelessly transmits the identifiers over the wireless telecommunications network to the server in real or near-real time as the identifiers are obtained by the RFID reader.

9. The race timing system of claim 7, wherein based upon the received identifiers the server updates the race data for the one or more racers in real or near-real time as the identifiers are received by the server.

10. The race timing system of claim 1, wherein the detector units are portable.

11. The race timing system of claim 10, wherein detector units are at least one of battery powered or solar powered.

12. The race timing system of claim 1, wherein each detector unit further comprises:
a microcontroller which controls operation of the RFID reader and wireless transmitter.

13. A method of establishing a racecourse and collecting and processing race data for one or more racers progressing along said racecourse, said method comprising:
providing a plurality of Radio Frequency IDentification (RFID) tags to a plurality of racers, each RFID tag being provisioned with an identifier which is distinguishable from the identifiers of the other RFID tags and each RFID tag being borne by a corresponding racer to thereby identify said corresponding racer with the identifier that the RFID tag is provisioned with;
positioning a plurality of detector units in an area where the racecourse is to be located;
selecting a first subset of the plurality of detector units, the selected subset of detector units defining a path which the racecourse follows;
wirelessly obtaining the identifiers from the RFID tags with the selected detector units as the RFID tags pass by the selected detector units;
wirelessly transmitting the obtained identifiers from the selected detector units over a wireless telecommunications network; and
receiving the transmitted identifiers at a server remotely located from the plurality of detector units.

14. The method of claim 13, wherein there are at least two racers which progress along the racecourse at different times.

15. The method of claim 13, said method further comprising:
altering the path of the racecourse without changing the positions of the plurality of detector units.

16. The method of claim 15, wherein said altering is achieved by selecting a second subset of the plurality of detector units, said second subset being different from the first subset.

17. The method of claim 13, wherein the detector units are affixed to their positions.

18. The method of claim 13, wherein the first subset includes less than all of the plurality of detector units.

19. The method of claim 13, wherein said method further comprises computing with said server at least one race result for the one or more racers in response to the server receiving the identifiers from the detector units.

20. The method of claim 19, wherein said method further comprises sending the at least one race result from the server over the wireless telecommunications network to a mobile device served by the wireless telecommunications network.
